(19) United States
(12) Patent Application Publication
(10) Pub. No.: US 2023/0096001 A1
(43) Pub. Date: Mar. 30, 2023

(54) SPRINKLER ALLOY FUSE

(71) Applicant: Injin JUNG, Seoul (KR)

(72) Inventor: Injin JUNG, Seoul (KR)

(21) Appl. No.: 17/802,481

(22) PCT Filed: Feb. 22, 2021
(86) PCT No.: PCT/KR2021/002180

§ 371 Date: Aug. 25, 2022

(30) Foreign Application Priority Data
Feb. 25, 2020 (KR) 10-2020-0022708

(51) Int. Cl. A62C 37/12

(52) U.S. Cl. CPC A62C 37/12

(57) ABSTRACT

A sprinkler head alloy fuse of the present invention enables, when a fire occurs, firefighting water that is in an always-pressed state to be strongly discharged and be reflected to a water reflection plate such that the fire can be rapidly and automatically suppressed, wherein the alloy fuse eccentrically couples a first lever and a second lever, is inserted into a heating tube, and is welded by a fusible low-temperature alloy. When a fire occurs and the ambient temperature reaches a sprinkler operation temperature, heat temperature transferred to the heating tube rapidly fuses the fusible low-temperature alloy, the heating tube is separated from a welded part by means of the elasticity of a spring mounted in a second lever groove, the central balance of the eccentrically coupled levers is broken, a nozzle plug is opened, and thus, a sprinkler head is operated. The alloy fuse of the present invention reduces high operation temperature deviation as in a glass fuse, precisely operates, maintains strong impact resistance, enables automatic production of a sprinkler head, and reduces manufacturing cost.

### TECHNICAL FIELD

The present disclosure relates to a sprinkler head, and more particularly, to a sprinkler head alloy fuse which quickly suppresses an initial fire by automatically spraying pressurized fire-fighting water by responding quickly when an ambient temperature reaches an operating temperature of the sprinkler head when the fire breaks out.

### BACKGROUND ART

Fire extinguishing sprinkler heads that automatically suppress an initial fire are required for large and tall buildings with development of large cities.

They are installed at different places while having different functions.

There are sprinkler heads that automatically operate when the ambient temperature rises and reaches the operating temperature.

Such sprinkler heads are installed to quickly put out the initial fire.

FIG. 1 is a cross-sectional view of a sprinkler head according to the prior art.

An alloy fuse welded with a fusible metal is coupled to the sprinkler head.

The sprinkler head according to the prior art includes: a frame 20, a fuse 50, a nozzle cap 30, and a deflector 40.

The frame 20 is connected to a water supply pipe 10 for supplying fire-fighting water.

The deflector 40 is coupled to a lower end of the frame 20 so as to radiate the pressurized fire-fighting water to a large area through the nozzle 21.

The shaft of the alloy fuse 50 may couple the nozzle cap 30 to the nozzle 21 with a strong force.

The assembly pressure may be adjusted by adjusting the height of a bolt 41.

The fuse 50 includes an eccentric lever 52 and a fusible metal 53.

Each component is connected and installed to support the nozzle cap 30.

With this connection, the eccentric lever 52 is coupled to an eccentric position outside the center line connecting the centers of the bold 41 and the nozzle pug.

The operation of the sprinkler head according to the prior art is described below.

When a fire breaks out, the ambient temperature reaches the operating temperature of the sprinkler as heat is transferred to the fusible metal 53.

Then, the fusible metal 53 is melted.

Thus, the levers 50.52 are connected. Then, the assembled eccentric balance is lost, and the levers are separated.

Then, the nozzle cap 30 is opened, and the pressurized fire-fighting water is ejected.

The ejected water is deflected on the deflector and sprayed onto a large area.

The sprinkler head is installed along with the construction of a building and is used for a semi-permanent life.

The sprinkler head according to the prior art may maintain the assembly load of the lever 50.51.52.

However, it cannot perform an early-response fuse function.

This results from the thickness of the lever and the low thermal conductivity of the connection lever.

The sprinkler head is designed to be assembled as follows.

Multiple levers are eccentrically fit and combined in a narrow space of the sprinkler head frame.

Accordingly, the production of sprinkler head cannot be automated.

The sprinkler head having such a structure cannot function as an early-response function.

This is because there is no installed component capable of accelerating heat transfer to the fusible metal 53.

Accordingly, compared to the standard response type sprinkler head, it has the following drawbacks.

The above-mentioned sprinkler head cannot be used widely. Nor can it operate quickly.

Accordingly, it cannot be applied to construction objects requiring fire suppression in the early stages.

### DISCLOSURE

### Technical Problem

It is one object of the present disclosure to provide an alloy fuse that is resistant to external impact as compared to a conventional glass fuse, and is very safe while having a small deviation of operating temperature.

It is another object of the present disclosure to provide an alloy fuse having strong durability against external impacts generated in the process of handling and installing a sprinkler head as to prevent sprinkler malfunction.

It is another object of the present disclosure to enable automated production of a sprinkler head as a finished product of a simple structure.

It is another object of the present disclosure to increase the competitiveness in terms of manufacturing cost of the sprinkler head.

It is another object of the present disclosure to provide an alloy fuse capable of performing a standard response function and an early-response function.

### Technical Solution

A sprinkler head according to the present disclosure includes:

a frame coupled to a water supply pipe to enable pressurized fire-fighting to be discharged through a central nozzle of the sprinkler head;

a nozzle cap of a frame nozzle closing means coupled to the water supply pipe;

a water deflector coupled to a lower portion of the frame;

an alloy fuse including a first lever, a second lever, and a heating tube,

the first and second levers and the heating tube being supported by a height adjustment means of a bolt fastened to a nut and weld-combined with a fusible metal; and

a nozzle cap coupled by the fuse.

A sprinkler is completed by coupling the fuse to the inside of the frame and adjusting a height with the bolt.

The fusible metal is quickly melted at the temperature of heat transferred to the heating tube welded to the first and second levers.

The heating tube is separated downward from the welded part by elasticity of the spring.

The function of the central axes of the first and second levers eccentrically combined with each other is extinguished.

Thereby, the sprinkler head is operated.

Preferably, a part of the top surface of the first lever is planar-machined so as to be eccentric.

The upper portion thereof is machined in a rectangular shape.

The planar-machined surface and the bending-machined surface of the second lever may be eccentrically coupled to the top surface of the first lever.

Preferably, the edge surface of the first lever and the second lever coupled to each other are machined to have bumps and recesses to increase the welding performance of the fusible metal and minimize loss of heat transferred to the heating tube.

Preferably, the upper end of the heating tube may be provided with a bent welding surface expanded to have a predetermined height.

Loss of the fusible metal welded to the concavo-convex grooves of the first and second lever may be prevented.

In addition, the fusible metal may be firmly welded to the heating tube.

Preferably, the spring may be coupled to a groove in the flat surface of the second lever.

In the process of welding the heating tube, both wings of the spring may be pushed up and seated on the bent part of the heating tube.

Thereby, spring elasticity may be enhanced.

Preferably, the first lever and the second lever may be eccentrically coupled and inserted into the heating tube.

Thereby, an alloy fuse installed in a central part of a sprinkler head by welding with a low temperature alloy may be provided.

### Advantageous Effects

The presented technology may have the following effects.

It should be noted that a specific embodiment does not include all the following effects or the following.

Therefore, it should not be understood that the scope of the disclosed technology is limited thereto.

According to the present disclosure, an alloy fuse may have strong durability against impacts generated during handling and installation, thereby preventing malfunction.

In addition, standard response and early-response sprinkler heads may be produced in an integrated structure whose production may be automated.

### DESCRIPTION OF DRAWINGS

FIG. 1 is a cross-sectional view of a sprinkler head according to the prior art.

FIG. 2 is a cross-sectional view of coupling of a sprinkler head and an alloy fuse according to an embodiment of the present disclosure.

FIG. 3 is a three-dimensional view of a first lever according to an embodiment of the present disclosure.

FIG. 4 is a three-dimensional view of a second lever according to an embodiment of the present disclosure.

FIG. 5 is a three-dimensional view of a heating tube according to an embodiment of the present disclosure.

FIG. 6 is a cross-sectional view of a compression spring according to an embodiment of the present disclosure.

FIG. 7 is a cross-sectional view of an alloy fuse assembly according to an embodiment of the present disclosure.

FIG. 8 is a three-dimensional view of a fusible metal according to an embodiment of the present disclosure.

FIG. 9 is a cross-sectional view of an operation according to an embodiment of the present disclosure.

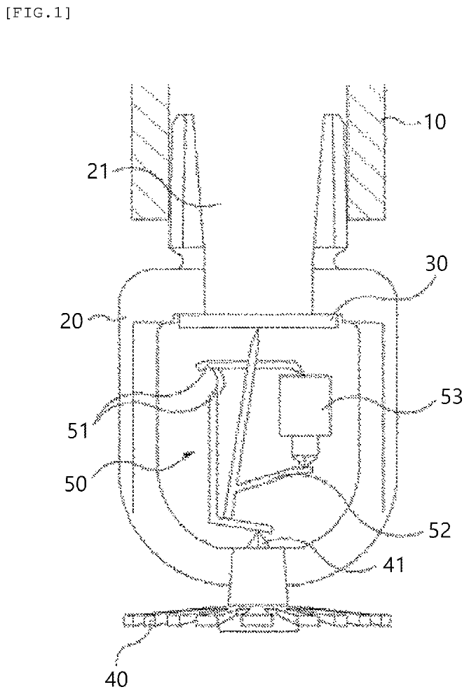

### BEST MODE

Hereinafter, a detailed description will be made with reference to with reference to the accompanying drawings.

Terms or words used in this specification should not be construed as limited to ordinary meanings or dictionary definitions.

Rather, they should be construed based on the principle that the inventor can appropriately define the concept of terms in order to explain the contents of the disclosure in the best way.

The configuration shown in the drawings is the most preferred embodiment of the present disclosure.

It does not represent all the technical ideas of the present disclosure.

Accordingly, similar modifications may be made at the time of filing of the present application.

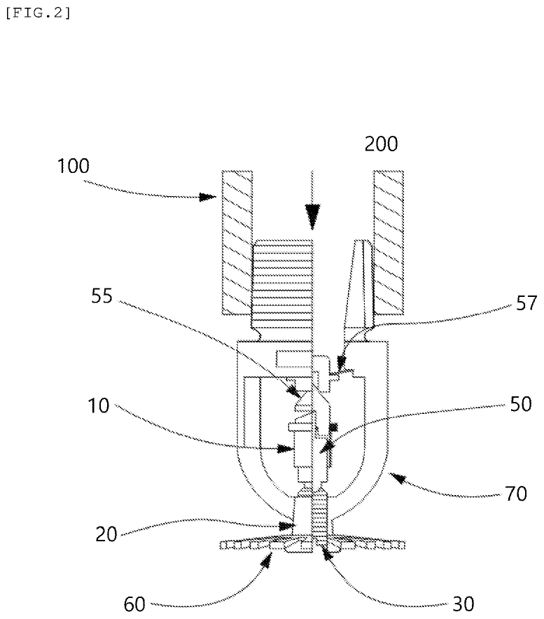

FIG. 2 is a cross-sectional view of a sprinkler head according to an embodiment of the present disclosure.

The figure illustrates the sprinkler head installed in a general building.

The sprinkler head according to the embodiment of the present disclosure includes:

a frame 70, a deflector 60, a fuse 50, and a nozzle cap 40.

It is coupled to a pipe 100.

Thus, pressurized fire-fighting water may be discharged through the nozzle 35 configured in the frame 70.

The deflector 60 is coupled to a lower end of the frame 70 for the purpose of spraying the pressurized fire-fighting water onto a large area.

Also, a bolt 30 is coupled to a lower end nut 20 of the frame 70 to adjust the height of the alloy fuse 50.

The bolt 30 is fastened to the nut 20 of the frame 70.

The lower end of the alloy fuse 50 is coupled to the bolt.

The upper round triangular horn 55 is coupled to a central groove 45 of the nozzle cap 40 to which the plate washer 57 is coupled.

When the height is adjusted with the bolt 30 fastened to the nut 20, the alloy fuse 50 is raised.

Then, the plate washer 57 coupled to the nozzle cap 40 may strongly close the nozzle inlet.

The sprinkler head assembled in this order may be installed in the pipe 100.

Thus, the sprinkler head is enabled to discharge pressurized fire-fighting water in an emergency.

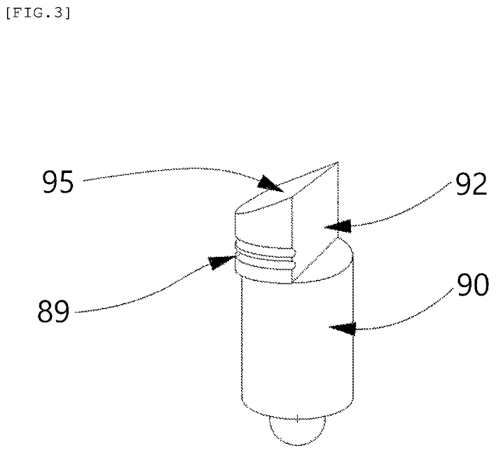

FIG. 3 is a three-dimensional view of a first lever 90 of the alloy fuse according to an embodiment of the present disclosure.

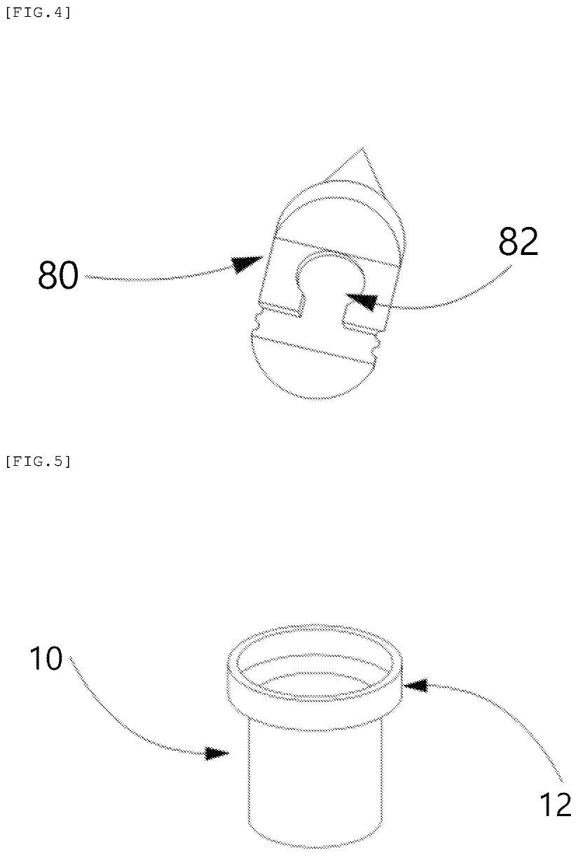

FIG. 4 is a three-dimensional view of a second lever 80 of the alloy fuse of the present disclosure.

A groove 82 is in a flat surface of the second lever 80 such that a spring 75 may be installed therein.

The alloy fuse 50 includes the first lever 90 and the second lever 80.

The joint part where the first lever and the second lever are coupled is inserted into the heating tube 10 and welded with a fusible metal 15.

The first lever 90 is formed by processing an upper cross section 95 in a rectangular shape.

The joint part coupled to the second lever is planar-machined (92), and combined with the planar-machined surface 82 of the second lever 80.

The bent part of the second lever is coupled to the upper rectangle 95 of the first lever.

Thus, the central axis of the first lever and the central axis of the second lever are eccentrically combined.

When the coupled bent part is inserted into the heating tube 10 and welded with the fusible metal 15, an alloy fuse that safely supports the assembly load of the sprinkler head is completed.

The first lever and the second lever are welded in the heating tube 10 of a metal material.

Accordingly, even when a strong instantaneous impact load pressure is generated in the sprinkler due to the waterhammer effect, the levers are not separated or displaced.

As the heating tube 10 is not separated from the welded part, malfunction of the sprinkler head may not occur.

The welded parts of the first and second levers coupled to the heating tube 10 of FIG. 5 include a concavo-convex groove 89.

Thus, welding strength of the fusible metal 15 may be increased, and loss of heat transferred to the heating tube 10 may be reduced as much as possible.

Thus, heat may be directly transferred to the fusible metal 15 to quickly melt the fusible metal.

Thereby, the alloy fuse may function as an early-response fuse.

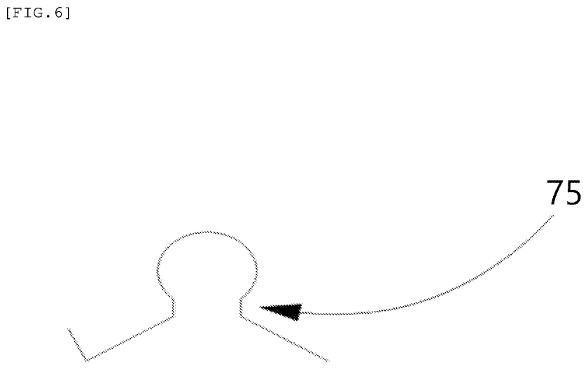

FIG. 6 is a cross-sectional view of the compression spring 75.

In the process of welding the heating tube 10 and the first and second levers together,

both wings of the compression spring 75 mounted in the groove 82 of the second lever are raised and seated on a bent part 12 at an upper end of the heating tube 10 with elasticity maintained.

Then, they are welded with the fusible metal 15.

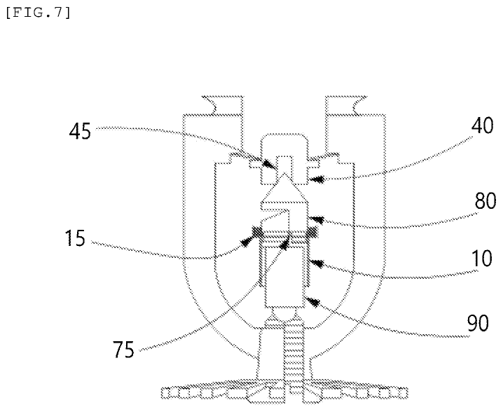

FIG. 7 is a partial plan view showing the alloy fuse of the present disclosure mounted in a sprinkler head.

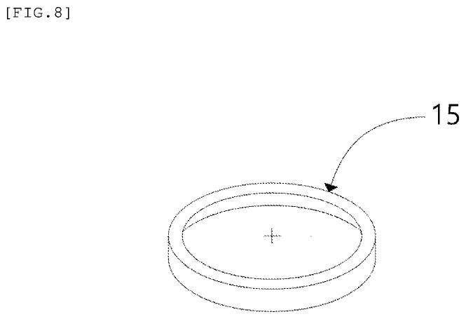

FIG. 8 is a three-dimensional view of the fusible metal. The fusible metal 15 is a type of lead that melts at a low temperature.

It melts at a lower temperature than the temperature (about 327° C.) at which normal lead is melted.

The fusible metal responses very accurately with a small deviation of temperature, compared to a glass fuse, which has a large deviation in operating temperature.

According to another embodiment of the present disclosure, the fusible metal 15 may include:

general lead, a fusible alloy, solder, or a mixture of lead and a metal such as thallium (TI), polonium (Po), bismuth (Bi), or the like having a melting point lower than that of lead.

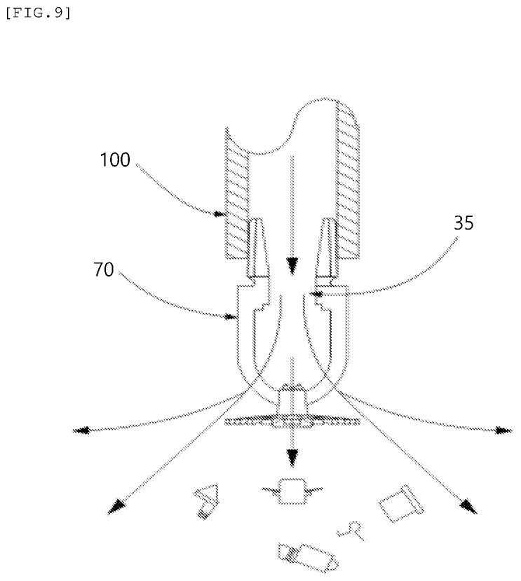

FIG. 9 illustrates the operation according to the present disclosure.

When a fire breaks out, the ambient temperature reaches the operating temperature of the sprinkler head, and the fusible metal 15 is melted.

The heating tube 10 is separated to the lower end by the elastic force of the compression spring 75 seated on the upper bent part 12 of the heating tube 10.

Also, the welded parts of the levers 1 and 2 eccentrically coupled to each other are separated to open the nozzle cap 40 that closes the inlet of the nozzle 35.

Then, the constantly pressurized fire-fighting water may be discharged and deflected on the deflector 60 to be sprayed on a large area.

Thereby, the sprinkler head may quickly extinguish the initial fire.

The alloy fuse of the sprinkler head according to the present disclosure is an alloy fuse 50 assembled in an integrated structure as follows.

The first lever 90 and the second lever 80 are eccentrically coupled and welded in the cylindrical heating tube 10 with the fusible metal 15.

Thus, the alloy fuse may be operated by elastic repulsive force of the compression spring 75.

The welding strength of the heating tube 10 is increased by forming bumps and recesses in the welded parts of the first and second levers.

Thus, when a fire breaks out, the fusible metal is quickly melted at the temperature of heat transferred to the heating tube 10.

Thereby, the sprinkler head is operated.

As described above, the technical ideas described in the present disclosure may be independently implemented.

Alternatively, they may be implemented in combination with each other.

This disclosure is not limited thereto.

Changes or modifications may be made to the present invention with reference to the invention by those of ordinary skill in the art.

### MODE FOR INVENTION

The sprinkler head according to the conventional technology for the fire extinguishing sprinkler is generally composed of:

a frame, a fuse, a nozzle cap, and a water deflector.

The frame is connected to a water supply pipe for supplying fire-fighting water.

The deflector is coupled to the lower end of the frame such that pressurized fire-fighting water may be radiated from the nozzle onto a large area.

The shaft of the alloy fuse may be coupled to the nozzle with a strong force.

Also, the assembly pressure of the bolt may be adjusted.

The alloy fuse according to the present functions as a sprinkler fuse to be operated sensitively.

Compared to the glass fuse, the alloy fuse of the sprinkler head according to the present disclosure may exhibit a very small deviation in operating temperature.

In addition, it may operate without an error.

### INDUSTRIAL APPLICABILITY

Large buildings and high-rise buildings in large cities can be very vulnerable to fires.

Large fires are often accompanied by huge property losses and human casualties.

For fire extinguishing facilities that can prevent large fires, installing a sprinkler head from may be most effective and is inexpensive.

Further, the sprinkler head may quickly and automatically suppress initial fires, thereby preventing initial fires from growing to large fires.

The alloy fuse according to the present functions as a sprinkler fuse to be operated sensitively.

Compared to the glass fuse, the alloy fuse of the sprinkler head according to the present disclosure may exhibit a very small deviation in operating temperature.

In addition, it may operate without an error.

List of reference numerals

| | |
|---|---|
| 200: Sprinkler head | 100: Pipe |
| 40: Nozzle cap | 20: Nut |
| 30: Bolt | 55: Round triangular horn |
| 45: Central groove | 35: Nozzle |
| 70: Frame | 60: Deflector |
| 75: Compression spring | 90: First lever |
| 80: Second lever | 10: Heating tube |
| 15: Fusible metal | 95: Upper cross section |
| 82: Second lever groove | 92: First lever planar machining |
| 89: Concavo-convex groove | 12: Heating tube bent surface |
| 50: Alloy fuse | 57: Plate washer |

1. A alloy fuse for a sprinkler head including a nozzle, a frame connected to a water supply pipe to enable pressurized fire-fighting water to be discharged strongly through the nozzle, a nut provided to a lower portion of the frame, a bolt of a height adjustment means coupled to the nut, and a water deflector coupled to a center of a lower end of the frame, the alloy fuse comprising:
a heating tube and first and second levers, the heating tube and the first and second levers being supported by the height adjustment means of the bolt welded with a fusible metal,
wherein, when a fire breaks out and an ambient temperature reaches an operating temperature of the sprinkler head:
the fusible metal is melted;
the heating tube is immediately moved to a lower end by elasticity of a spring mounted on the second lever; and
the eccentrically coupled first and second levers are separated and operated.

2. The alloy fuse of claim 1, further comprising:
a compression spring mounted in a central groove formed in a flat surface of the second lever,
wherein, when the fusible metal is melted, the heating tube is quickly separated and moved to the lower end by elasticity of the spring,
wherein opposite wings of the spring are coupled to an upper portion of the heating tube, and
wherein one side of the spring is folded up to allow visual confirmation of mounting of the spring after welding.

3. The alloy fuse of claim 1, wherein a central axis of the first lever and a central axis of the second lever are eccentrically coupled such that welded parts of the levers separated and operated when the levers are subjected to load pressure,
wherein the heating tube is welded to maintain a pressure load to safely support the load pressure,
wherein the welded parts of the first and second levers are provided with bumps and recesses to increase a welding strength of the heating tube and minimize loss of heat transferred to the heating tube such that the fusible metal is quickly melted.

4. The alloy fuse of claim 1 or 2, wherein a rim of an upper part of the heating tube is bent and extended to maintain a predetermined height so as to be welded with the fusible metal,
wherein a bent surface of the rim is bent wide to allow the molten fusible metal and the opposite wings of the spring to be seated thereon at the predetermined height and welded with the welded parts of the levers,
wherein the alloy fuse operates as a standard response fuse or an early-response fuse depending on a length of the heating tube.
